(19) United States
(12) Patent Application Publication
(10) Pub. No.: US 2009/0293038 A1
(43) Pub. Date: Nov. 26, 2009

(54) METHOD AND CORRECTION APPARATUS FOR CORRECTING PROCESS PROXIMITY EFFECT AND COMPUTER PROGRAM PRODUCT

(76) Inventors: Shimon MAEDA, Tokyo (JP); Suigen KYOH, Yokohama-shi (JP); Satoshi TANAKA, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/470,334

(22) Filed: May 21, 2009

(30) Foreign Application Priority Data
May 23, 2008 (JP) 2008-135756

(51) Int. Cl. G06F 17/50

(52) U.S. Cl. 716/19

(57) ABSTRACT

A process proximity effect (PPE) correction method includes providing corrected cells arranged in a place/route arrangement, the corrected cells being obtained by correcting design data of a semiconductor device based on correction value for correcting PPE correction, determining whether a cell arrangement of the corrected cells is registered or not based on environmental profiles, conducting lithography verification if the corrected cells includes the cell arrangement not registered in the environmental profiles, the verification being performed on the corrected cells, wherein the corrected cell to be conducted the verification corresponds to the cell arrangement not registered, determining whether error is found or not in the verification, correcting the corrected cell to which the verification is conducted if the error is found and registering the cell arrangement in the environmental profiles, and registering the cell arrangement of the corrected cell if the error is not found.

### CROSS-REFERENCE TO RELATED APPLICATIONS

This application is based upon and claims the benefit of priority from prior Japanese Patent Application No. 2008-135756, filed May 23, 2008, the entire contents of which are incorporated herein by reference.

### BACKGROUND OF THE INVENTION

1. Field of the Invention

The present invention relates to a graphics processing method for design data of a semiconductor integrated circuit device and more particularly to a method and correction apparatus for correcting process proximity effect and computer program product.

2. Description of the Related Art

As a semiconductor integrated circuit device advance in fine patterning, it becomes increasingly difficult to obtain finished patterns (patterns formed on a substrate) faithful to design data. The disturbance of the faithfulness appears as a dimensional difference between a portion in which the period of patterns is small (dense area) and a portion in which the pattern period is large (sparse area).

In general, the phenomenon by which patterns cannot be formed as they were designed due to light is called the optical proximity effect (OPE). In addition, the phenomenon by which patterns cannot be formed as they were designed due to light and the phenomenon by which patterns cannot be formed as they were designed due to processes, such as development, etching, etc., are collectively called the process proximity effect (PPE).

In order to solve the problem of OPE or PPE, it is required to use mask patterns different from design pattern so that the dimensions and shapes of finished patterns become identical to those of design pattern. For this reason, what is called the mask data processing becomes important which is carried out when mask patterns different from design pattern are produced.

For example, Jpn. Pat. Appln. KOKAI Publications Nos. 2002-328457 and 2005-84101 disclose methods comprising preparing a library made up of cells which are corrected for OPC in advance and placing the cells for the purpose of reducing the turnaround time (TAT) of OPC processing.

However, these methods do not ensure sufficient accuracy.

### BRIEF SUMMARY OF THE INVENTION

According to an aspect of the present invention, there is provided a method for correcting process proximity effect, the method comprising: providing a plurality of corrected cells which are arranged in a place/route arrangement, the plurality of corrected cells being obtained by correcting design data of a semiconductor integrated circuit device based on correction value for correcting process proximity effect correction; determining whether a cell arrangement of the plurality of corrected cells arranged in the place/route arrangement is registered or not based on environmental profiles; conducting a lithography verification if the plurality of corrected cells is determined to include the cell arrangement which is not registered in the environmental profiles, the lithography verification being performed on the plurality of corrected cells, wherein the corrected cell to be conducted the lithography verification corresponds to the cell arrangement not registered; determining whether an error is found or not in the lithography verification; correcting the corrected cell to which the lithography verification is conducted if the error is found and registering the cell arrangement of the corrected cell to which the lithography verification is conducted in the environmental profiles; and registering the cell arrangement of the corrected cell to which the lithography verification is conducted if the error is not found.

According to an aspect of the present invention, there is provided a correction apparatus for correcting process proximity effect, the correction apparatus comprising: an input unit configured to input design data of a semiconductor integrated circuit device; a lithography verification unit configured to perform a lithography verification for correcting process proximity effect of the design data; a proximity effect correction process unit configured to correct correction value when an error is detected in a lithography verification by the lithography verification unit; an environmental profile creating unit configured to create an environmental profile of a target cell and surrounding cells of the target cell; a storage unit configured to store the design data, verification result of the lithography verification, correction result of the correction value, and the environmental profile; an output unit configured to output the verification result of the lithography verification, and the correction result of the correction value; a control unit configured to control operations of the input unit, the storage unit, the output unit, the lithography verification unit, the process proximity effect correction process unit, and the environmental profile creating unit; wherein when the process proximity effect correction of the design data is performed, inputting a plurality of corrected cells which are arranged in a place/route arrangement, the plurality of corrected cells being obtained by correcting design data of a semiconductor integrated circuit device based on correction value for correcting process proximity effect correction, determining whether a cell arrangement of the plurality of corrected cells arranged in the place/route arrangement is registered or not based on environmental profiles by using the control unit based on storage information stored in the storage unit; conducting a lithography verification by the lithography verification unit if the plurality of corrected cells is determined to include the cell arrangement which is not registered in the environmental profiles, the lithography verification being performed on the plurality of corrected cells, wherein the corrected cell to be conducted the lithography verification corresponds to the cell arrangement not registered; determining whether an error is found or not in the lithography verification by the control unit; correcting the corrected cell to which the lithography verification is conducted by the proximity effect correction process unit if the error is detected and storing the cell arrangement of the corrected cell to which the lithography verification is conducted in the environmental profiles; storing the cell arrangement of the corrected cell to which the lithography verification is conducted in the storage unit if the error is not detected.

According to an aspect of the present invention, there is provided a computer program product configured to store program instructions for execution on a computer system enabling the computer system to perform: an instruction to provide a plurality of corrected cells which are arranged in a place/route arrangement, the plurality of corrected cells being obtained by correcting design data of a semiconductor integrated circuit device based on correction value for correcting process proximity effect correction; an instruction to determine whether a cell arrangement of the plurality of corrected cells arranged in the place/route arrangement is registered or not based on environmental profiles; an instruction to conduct a lithography verification if the plurality of corrected cells is determined to include the cell arrangement which is not registered in the environmental profiles, the lithography verification being performed on the plurality of corrected cells, wherein the corrected cell to be conducted the lithography verification corresponds to the cell arrangement not registered; an instruction to correct the corrected cell to which the lithography verification is conducted if the error is found and registering the cell arrangement of the corrected cell to which the lithography verification is conducted in the environmental profiles; and an instruction to the cell arrangement of the corrected cell to which the lithography verification is conducted if the error is not found.

### BRIEF DESCRIPTION OF THE SEVERAL VIEWS OF THE DRAWING

FIG. 1 is a schematic block diagram of a process proximity effect correction apparatus according to a first embodiment;

FIG. 2 is a flowchart illustrating a process proximity effect correction method according to the first embodiment;

FIG. 3 shows preprocessing steps of lithography verification in the process proximity effect correction method shown in FIG. 2;

FIG. 4 is a pattern plan view illustrating correction by intercell wirings (design data) in the post-OPC data recreation step in the preprocessing steps of lithography verification shown in FIG. 3;

FIG. 5 is a flowchart illustrating a specific example of the lithography verification step in the process proximity effect correction method shown in FIG. 2;

FIG. 6 is a pattern plan view illustrating the results of simulation obtained by the lithography verification shown in FIG. 5;

FIG. 7 is a flowchart illustrating a specific example of the step of correcting correction values in the process proximity effect correction method shown in FIG. 2;

FIG. 8 is a pattern plan view illustrating the step of identifying lithography faulty portions in the flowchart shown in FIG. 7;

FIG. 9 is a flowchart illustrating the step of creating a correction value reexamination area and the step of extracting a segment for reprocessing in the flowchart shown in FIG. 7;

FIG. 10 is a pattern plan view illustrating the method of correcting the correction values when incremental OPC is used in the re-OPC step in the flowchart shown in FIG. 7;

FIG. 11 is a flowchart illustrating another specific example of the step of correcting the correction values in the process proximity effect correction method shown in FIG. 2;

FIGS. 12A through 12F are pattern plan views illustrating the method of cell selection in the flowchart shown in FIG. 11;

FIG. 13 is a diagram for use in explanation of another example of the method of cell selection in the flowchart shown in FIG. 11;

FIG. 14 is a flowchart illustrating the step of creating an environmental profile in the process proximity effect correction method shown in FIG. 2;

FIG. 15 is a plan view for use in explanation of the relationship between a target cell and its surrounding cells in the environmental profiles creation step shown in FIG. 14;

FIG. 16 is a diagram for use in explanation of the environmental profiles of the target cell shown in FIG. 15;

FIG. 17 is a diagram for use in explanation of an evaluation function created in the environmental profiles creation step shown in FIG. 14;

FIG. 18 is a diagram for use in explanation of statistical analysis of arrangement conditions under which errors occur;

FIG. 19 is a pattern plan view for use in explanation of analyses of the arrangement conditions under which errors occur the evaluation function;

FIG. 20 is a flowchart illustrating the method of replacement of cells in the process proximity effect correction method shown in FIG. 2;

FIG. 21 is a flowchart illustrating a process proximity correction method according to a second embodiment and another method of lithography verification;

FIG. 22 is a plan view illustrating the concept of the lithography verification method shown in FIG. 21;

FIG. 23 is a flowchart illustrating redivision of an area in the lithography verification method shown in FIG. 21;

FIGS. 24A and 24B are pattern plan views illustrating the arrangement of divided subareas in the lithography verification method shown in FIG. 23;

FIG. 25 is a pattern plan view illustrating the step of combining the divided subareas in the lithography verification method shown in FIG. 23;

FIG. 26 is a pattern plan view illustrating the step of creating a reverification area in the lithography verification method shown in FIG. 23;

FIG. 27 is a pattern plan view illustrating the redivision step in the lithography verification method shown in FIG. 23;

FIG. 28 is a flowchart illustrating a process proximity correction method according to a third embodiment and another concept of the lithography verification method shown in FIG. 21;

FIG. 29 is a flowchart illustrating the lithography verification method shown in FIG. 28;

FIGS. 30A and 30B are pattern plan views illustrating the arrangement of cells in the lithography verification method shown in FIG. 29;

FIG. 31 is a pattern plan view illustrating the step of combining the divided subareas in the lithography verification method shown in FIG. 29;

FIG. 32 is a pattern plan view illustrating the step of creating a reverification area in the lithography verification method shown in FIG. 29;

FIG. 33 is a pattern plan view illustrating the redivision step in the lithography verification method shown in FIG. 29;

FIGS. 34A and 34B are pattern plan views for use in explanation of a process proximity effect correction method according to a fourth embodiment and still another lithography verification method;

FIG. 35 is a pattern plan view for use in explanation of the process proximity effect correction method according to the fourth embodiment and a further lithography verification method;

FIG. 36 is a flowchart illustrating a process proximity correction method according to a fifth embodiment and still another method of lithography verification;

FIG. 37 is a pattern plan view illustrating observation points in the lithography verification method shown in FIG. 36; and

FIG. 38 illustrates a computer program product of the embodiment.

### DETAILED DESCRIPTION OF THE INVENTION

The embodiments of the present invention will be described hereinafter with reference to the accompanying drawings.

### First Embodiment

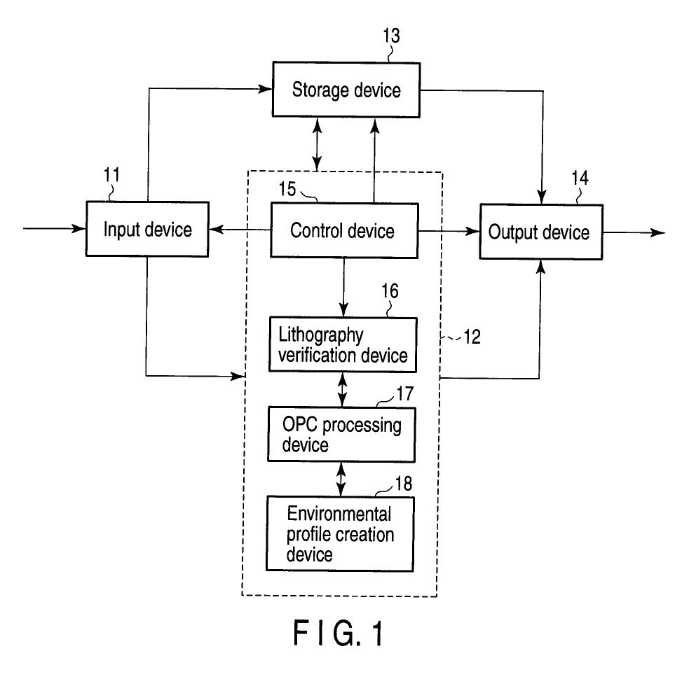

FIG. 1 is a schematic block diagram of a process proximity effect correction apparatus according to a first embodiment.

The correction apparatus comprises an input device 11, such as a console or a keyboard, which inputs design data of a semiconductor integrated circuit device, a processing device 12 which performs various processes and control to correct the process proximity effect, a storage device 13 which is comprised of a semiconductor memory or a hard disk driver to store the design data, the results of lithography verification, the results of correction of correction values, created environmental profiles, etc., and an output device 14, such as a monitor or a printer.

The processing device 12 includes a control device 15, a lithography verification device 16, an optical proximity effect correction (OPC) processing device 17, and an environmental profile creation device 18. The control device 15 controls the operations of the input device 11, the storage device 13, the output device 14, the lithography verification device 16, the OPC processing device 17, and the environmental profile creation device 18.

The storage device 13 is stored with design pattern. Further, the storage device is stored with operation and relational expressions for process proximity effect correction of the design pattern, which are written as a program. In addition, the storage device is stored with design data, various device parameters, and their initial values, which are input from the input device 11 (they may be prestored).

The lithography verification device 16 is adapted to perform lithography verification for process proximity effect correction. The results of the lithography verification are stored in the storage device 13. The OPC processing device 17 is adapted to further correct correction values when errors are detected in the lithography verification by the lithography verification device 16. The results of correction are stored in the storage device 13. The environmental profile creation device 18 creates an environmental profile in the state corrected by the OPC processing device 17. The created environmental profiles are stored in the storage device 13.

The output device 14 is adapted to display the results of lithography verification by the lithography verification device 16 and the results of OPC by the OPC processing device 17 and print out them when necessary.

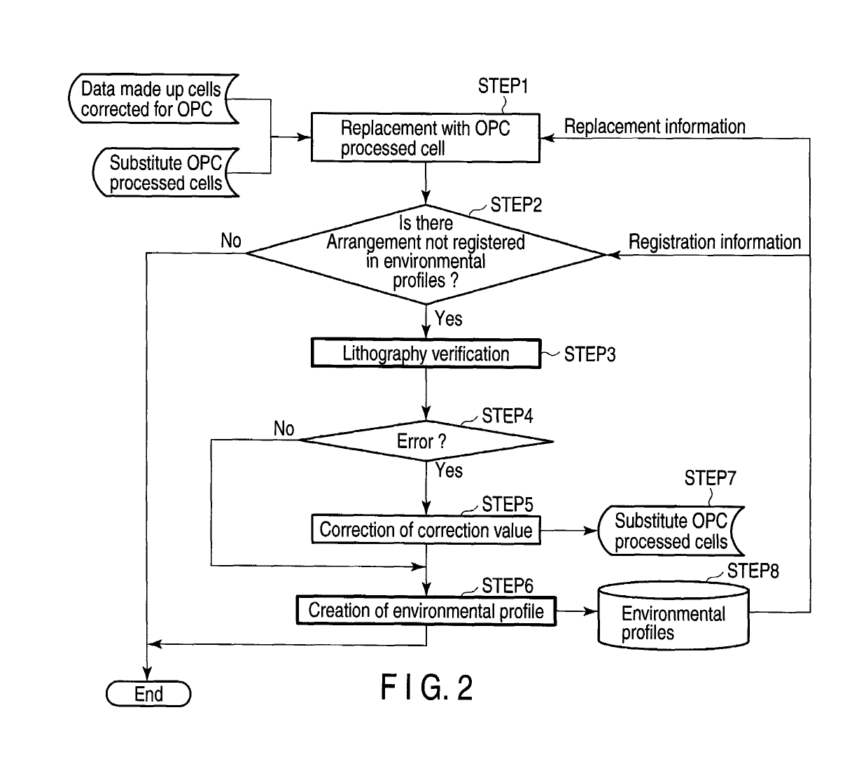

Next, a method of correcting the process proximity effect using the above-stated configuration according to the first embodiment will be described with reference to a flowchart of FIG. 2.

First, data having a number of correction cell patterns arranged in a place/route arrangement (layout) and interconnected (data made up cells corrected for OPC) are input from the input device 11. If substitute OPC processed cells are registered in the storage device 13, they are replaced with the OPC processed cells on the basis of replacement information (environmental profiles) stored in the storage device (STEP 1).

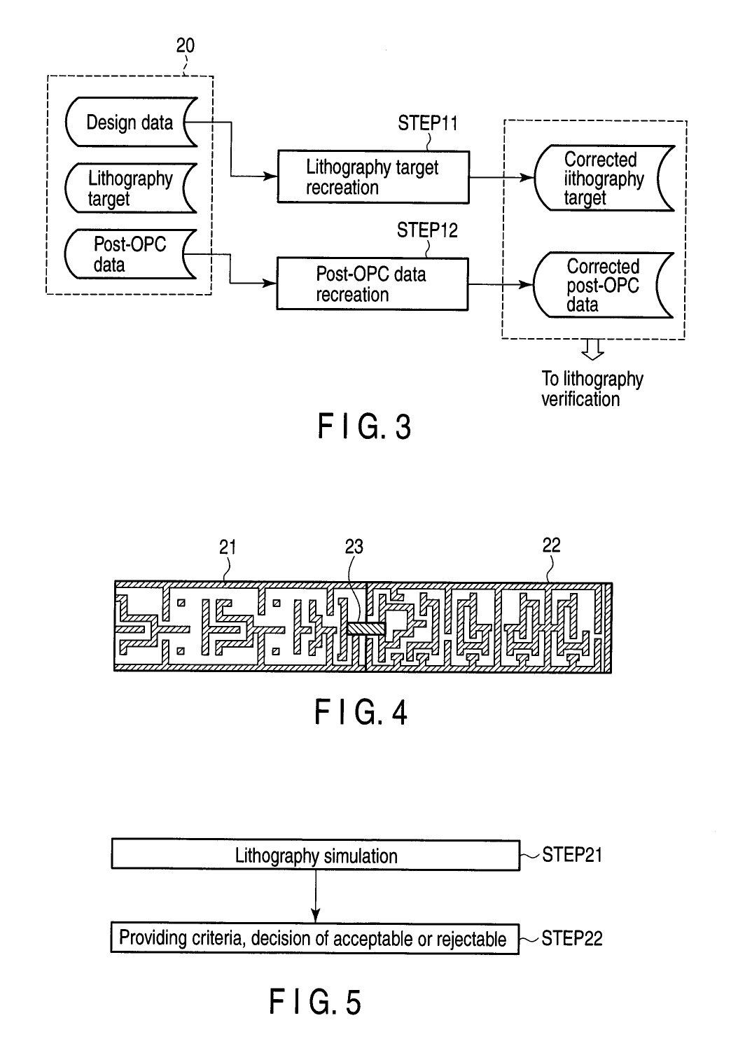

In this preprocessing step, as shown in FIG. 3, a lithography target is recreated using design data from information of design data, a lithography target and post-OPC data contained in an OPC processed cell 20 (STEP 11). Moreover, the post-OPC data is also recreated (post-OPC data+intercell wirings) (STEP 12). The corrected lithography target obtained in STEP 11 and the corrected post-OPC data obtained in STEP 12 are sent to the lithography verification device 16.

The reason why the lithography target is recreated is that the lithography target contained in the original correction cell pattern and the actual lithography target after arranging the place/route arrangement may differ in shape.

The reason why the post-OPC data is recreated is as follows: In the presence of an intercell wiring 23 that connects cells 21 and 22 together as shown in FIG. 4, that wiring is not contained in the correction cell pattern. For this reason, if verification is made only on the correction cell pattern, a defect of the wiring 23 might be missed. Accordingly, the present method handles the intercell wiring (design data) 23 as post-OPC data and adds it to the correction cell pattern to recreate the post-OPC data.

Subsequently, a decision is made as to whether or not there is an arrangement (layout) which is not registered in the environmental profile on the basis of information registered in the storage device 13 (STEP 2).

If there is such an arrangement, lithography verification is carried out by the lithography verification device 16 (STEP 3); otherwise, the procedure is completed because only the information registered in the storage device suffices. In this lithography verification, such verification as shown in FIG. 5 is made on the corrected lithography target and the corrected post-OPC data on the basis of a lithography simulation.

The lithography simulation (STEP 21) is carried out on all of areas and takes into consideration cell boundaries and the periphery of intercell wirings. As the lithography conditions, the dose and the focus value are each changed within a given range. The simulation is carried out including the optimum dose, deviated doses, the optimum focal point, and out-of-focus points. Criteria are set up to judge the quality (STEP 22). Verification items that provide criteria for judgment include bridge errors, necking errors, edge variation errors, hole coverage errors, tolerance violations, data miss and data extra. These items are detected for verification.

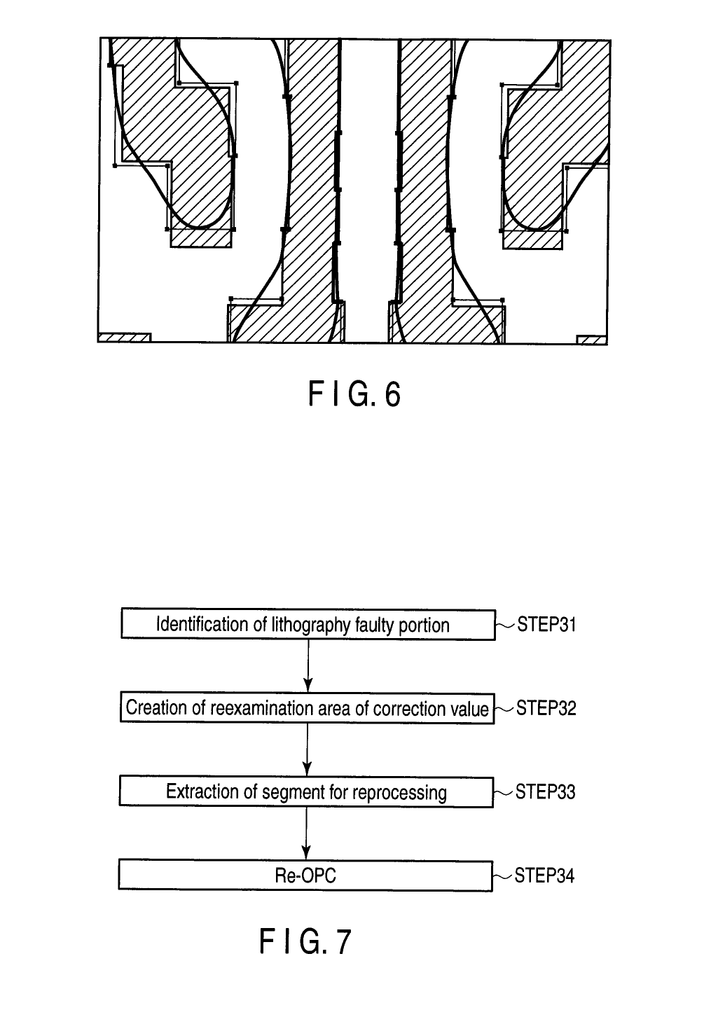

In this way, such lithography simulation results as indicated by curved lines in FIG. 6 are obtained for design data indicated hatched.

Subsequently, a decision is made of the presence or absence of errors in the lithography verification (STEP 4). In the presence of errors, the OPC processing device 17 corrects correction values (STEP 5). Then, the environmental profile creation device 18 creates an environmental profile (STEP 6).

In the absence of any error, on the other hand, an environmental profile is created without correcting the correction value (STEP 6). The corrected correction value and the created environmental profile are each stored in the storage device 13 (STEP 7 and STEP 8).

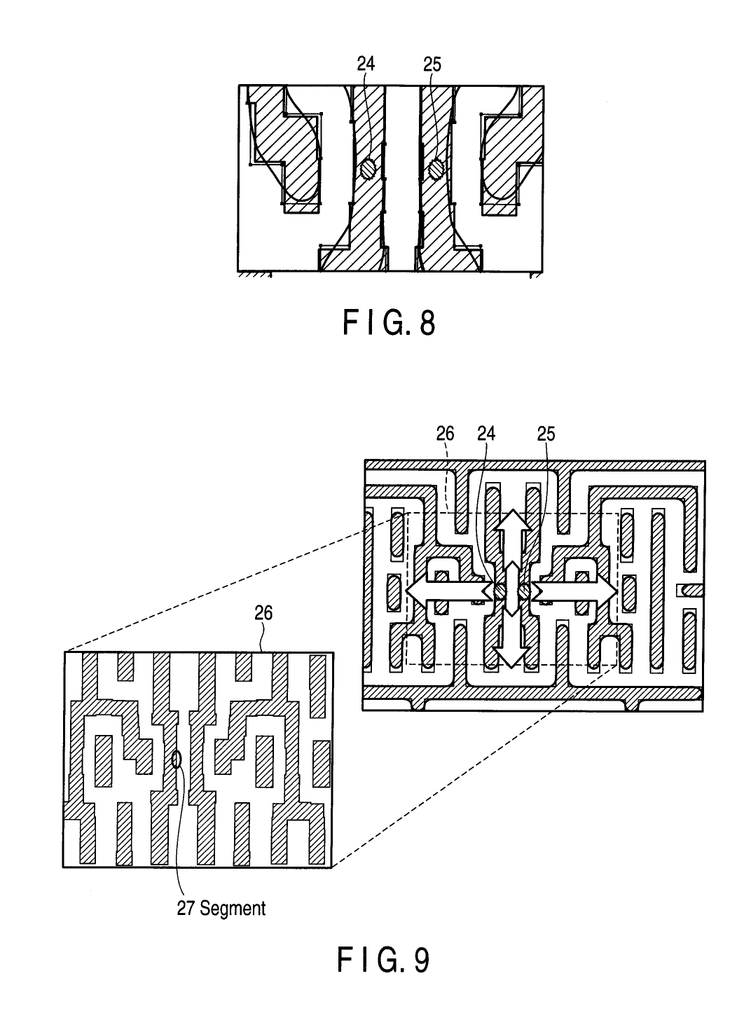

Next, a method of correcting the correction values in the presence of errors in the lithography verification will be described in more detail with reference to a flowchart of FIG. 7 and pattern plan views of FIGS. 8, 9 and 10.

As shown in FIG. 8, faulty portions (lithography faulty portions; here, areas in which the wiring width becomes narrower than a given value) 24 and 25 are identified (STEP 31). As shown by arrows in FIG. 9, the faulty portions 24 and 25 are extended to a certain fixed range (e.g., optical radius of 1 μm) to create a correction-value reexamination area (correction area) 26 (STEP 32).

Next, a segment 27 for correction contained in the correction area 26 is extracted (STEP 33). Then, the OPC processing device 17 carries out OPC on the extracted segment 27 again (STEP 34).

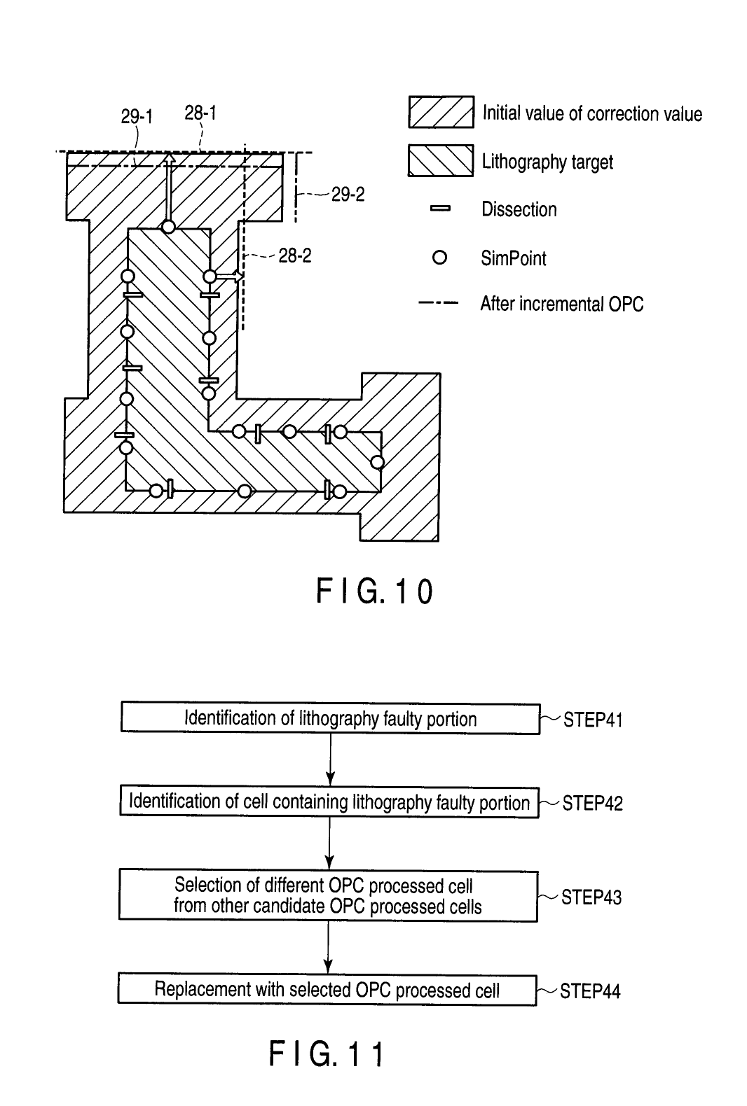

The re-OPC methods are divided into two methods: the usual method of correction with a lithography target as a starting point; and the so-called incremental OPC method which makes corrections with the shape of a correction cell pattern as a starting point as shown in FIG. 10.

In the incremental OPC, the area indicated in FIG. 10 with oblique lines which are downward to the right is the lithography target and the area with oblique lines which are upward to the right is the initial value of the correction value. Upon execution of the OPC with broken lines 28-1 and 28-2 as initial values, the correction values become as indicated by dashed-and-dotted lines 29-1 and 29-2 after the incremental OPC. This method can reduce the number of iterations and has therefore an advantage of reduced processing time.

Next, another method of correcting the correction values in the presence of errors in the lithography verification will be described in more detail with reference to FIGS. 11, 12A, 12B and 13.

As shown in the flowchart of FIG. 11, faulty portions (lithography faulty portions; here, areas in which the wiring width becomes narrower than a given value) are identified (STEP 41). Then, a cell that contains the lithography faulty portions is identified (step S42).

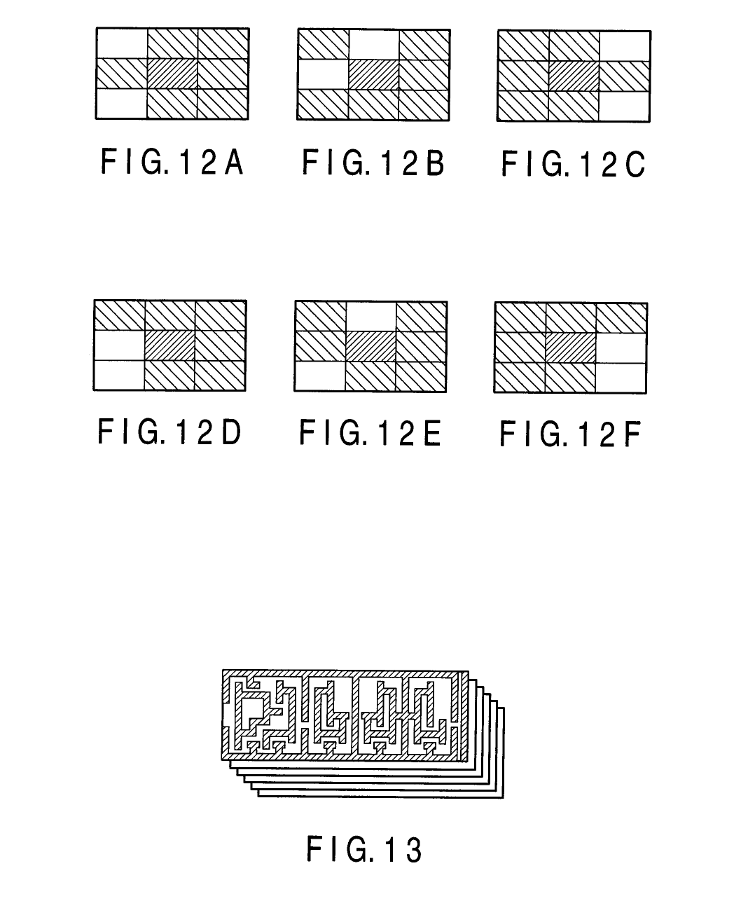

At this point, peripheral-cell arrangement information stored in the storage device 13 is considered. For example, a plurality of cell arrangement patterns are prepared in advance each of which contains a total of nine cells of a cell having lithography faulty portions (the central cell with oblique lines which are directed upward to the right) and eight cells surrounding that cell (cells with oblique lines which are directed downward to the right and cells with no oblique lines) as shown in FIGS. 12A to 12F. The optimum correction cell pattern is selected from among those patterns.

Alternatively, as shown in FIG. 13, all the cell information stored in the storage device 13 may be selected piece by piece for comparison with one another to select the optimum correction cell pattern.

In this way, a different OPC processed cell is selected from other candidate OPC processed cells (STEP 43).

Next, the OPC processing device 17 carries out replacement with the selected OPC processed cell (STEP 44).

After the lithography verification, the corrected pattern is retained as a substitute cell pattern for replacement (substitute OPC processed cell) which is needed in the subsequent replacement work (STEP 7).

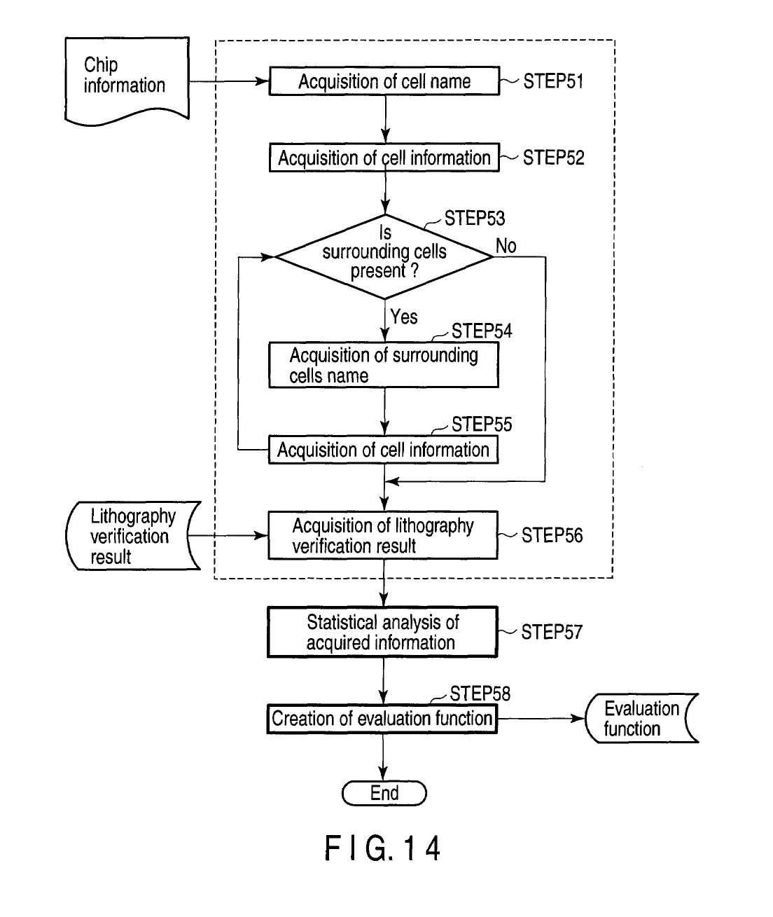

Next, reference is made to FIGS. 14 through 19 to describe the creation of an environmental profile.

As shown in the flowchart of FIG. 14, a cell name is first obtained from chip information (STEP 51) and then information of this cell is obtained (STEP 52).

Here, for data made up of OPC processed cells input from the input device 11 in STEP 1, arrangement information is obtained which contains at least one of the cell name of a correction cell pattern of interest (target cell), rotation information of the cell, inversion information of the cell, the coordinates of the cell, the size of the cell, the shape of the pre-correction cell pattern, the number of vertices of the pre-correction cell pattern, the shape of the post-correction cell pattern, and the number of vertices of the post-correction cell pattern.

Next, a decision is made as to whether cells are present in the periphery of the target cell (STEP 53).

If such cells are present, their names are obtained (STEP 54) and moreover their information other than the names is obtained (STEP 55).

As the cell information, as in STEP 52, arrangement information is obtained which contains at least one of the cell rotation information, the cell inversion information, the cell coordinates, the cell size, the pre-correction cell pattern shape, the number of vertices of the pre-correction cell pattern, the shape of the post-correction cell pattern, and the number of vertices of the post-correction cell pattern.

After the acquisition of such cell information, a return is made to STEP 63. That is, as long as surrounding cells remain, their names and information other than the names are acquired in succession.

Thus, the names and information other than the names of the target cell and the surrounding cells are acquired. If the decision in STEP 53 is that surrounding cells are present no longer, an environmental profile expressed in a particular form is created on the basis of the results of verification (STEP 56) by the aforementioned lithography simulation.

The creation of the environmental profile is to create an evaluation function by statistical analysis (STEP 57) of the acquired information (STEP 58). The resulting evaluation function is stored in the storage device 13. Thereby, referring to the environmental profile makes it possible to see which arrangement environment develops lithography errors.

By referring to the evaluation function (environmental profile) created in such a way as described above, a cell having a cell arrangement that develops lithography errors is identified from input data and, at the same time, a cell that substitutes for that cell is provided. Thus, possible lithography errors can be avoided by replacing the originally arranged cell with the substitute cell.

Next, discrimination is made between an area in the input data which is described in the environmental profiles and an area which is not.

Here, the area described in the environmental profiles is one in which discrimination can be clearly made between a cell which develops a lithography error and a cell which does not. On the other Hand, the area not described in the environmental profile is one for which a decision cannot be made of whether or not lithography errors occur.

If all the areas are described in the environmental profiles, this means that all the cells that develop lithography errors are replaced with cells that do not develop errors. At the termination of replacement, lithography simulation-based verification becomes unnecessary.

In contrast, if there is an area which is not described in the environmental profiles, lithography simulation-based verification is made again on that area. In the event that error occurs after verification, the correction pattern is corrected as described above and moreover the environmental profiles is updated.

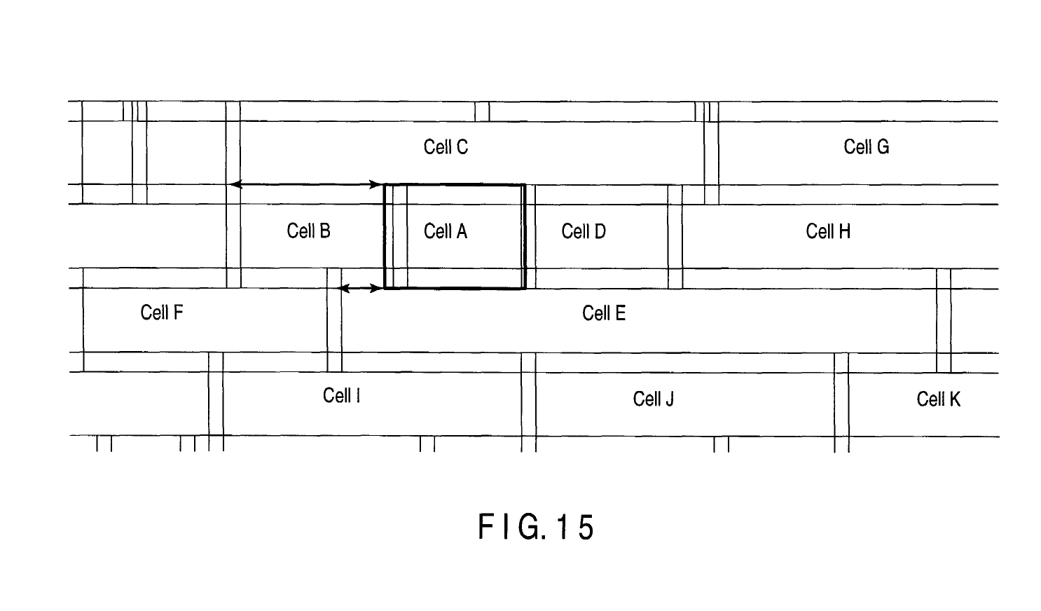

Next, the creation of the environmental profile will be described in detail with reference to FIGS. 15 through 19.

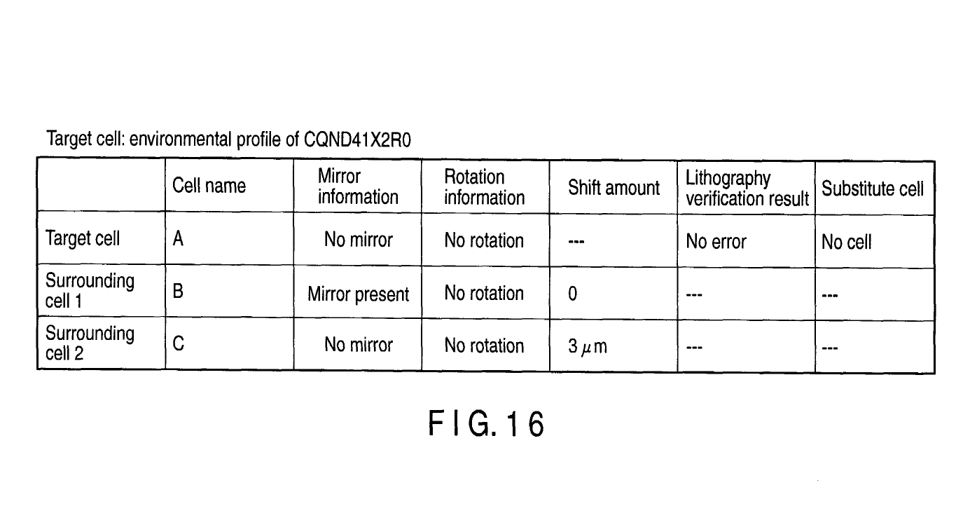

Suppose that cells B, C, D and E are arranged around a target cell A as shown in FIG. 15. In this case, as shown in FIG. 16, the environmental profile of the target cell A has the names of the target cell and the surrounding cells 1 and 2, mirror information, rotation information, shift amount, lithography verification results, and the presence or absence of substitute cells, which are stored in the storage device 13.

Subsequently, the results of verification based on lithography simulation of the target cell are obtained. Then, analysis is made on the basis of the obtained cell information.

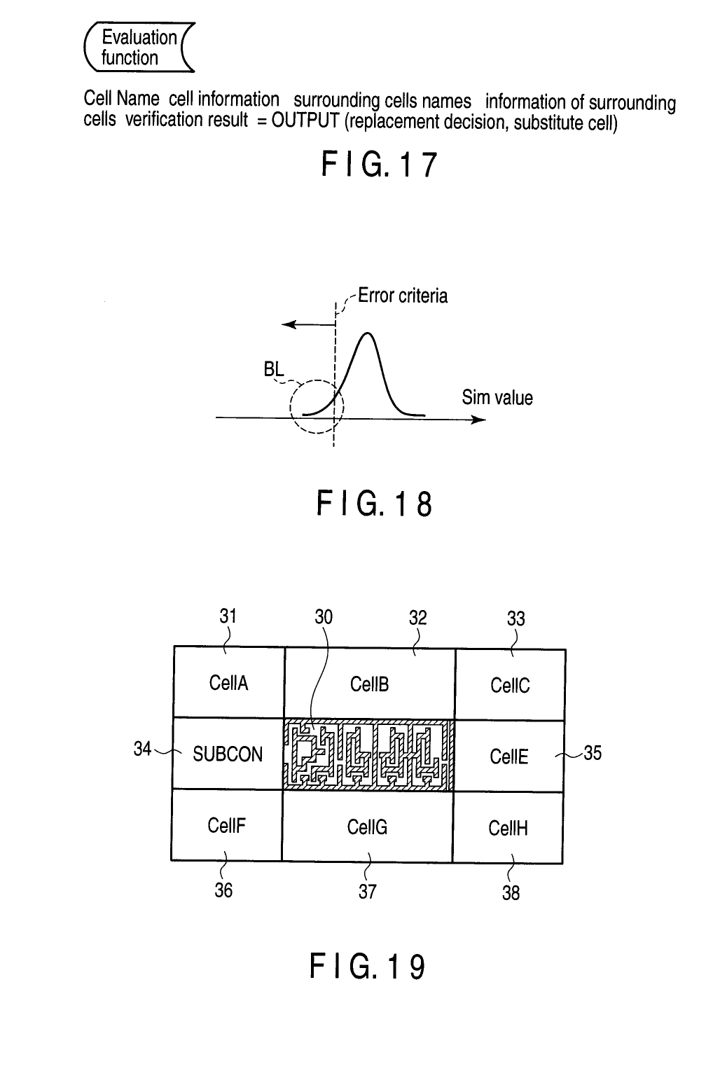

The aforementioned evaluation function is set up based on the name of the target cell, the cell information other than the names, the names of surrounding cells, the information other than the names of the surrounding cells, and the results of verification as shown in FIG. 17. Using the evaluation function, a decision is made of whether to replace and cells to be replaced are identified.

If the statistical analysis indicates that lithography errors occur only when a cell called SUBCON is placed on the left side of the target cell by way of example, when an environment in which the cell SUBCON is placed to the left is input, the decision that the cell must be replaced and the name of the cell to be replaced are output.

As the result of statistical analysis of the cell arrangement conditions which occurs the error, for example, as shown in FIG. 18, in the range of the simulation value (Sim Value) in which the range is defined by broken line BL that is not higher than the error criteria, all the cell SUBCON are placed to the left, the result is as follows.

When the cell (SUBCON) 34 is placed to the left of the target cell 30 as shown in FIG. 19, errors occur without fail. For this reason, when the cell SUBCON is placed to the left, it is replaced with another cell which is an improved version but has the same function.

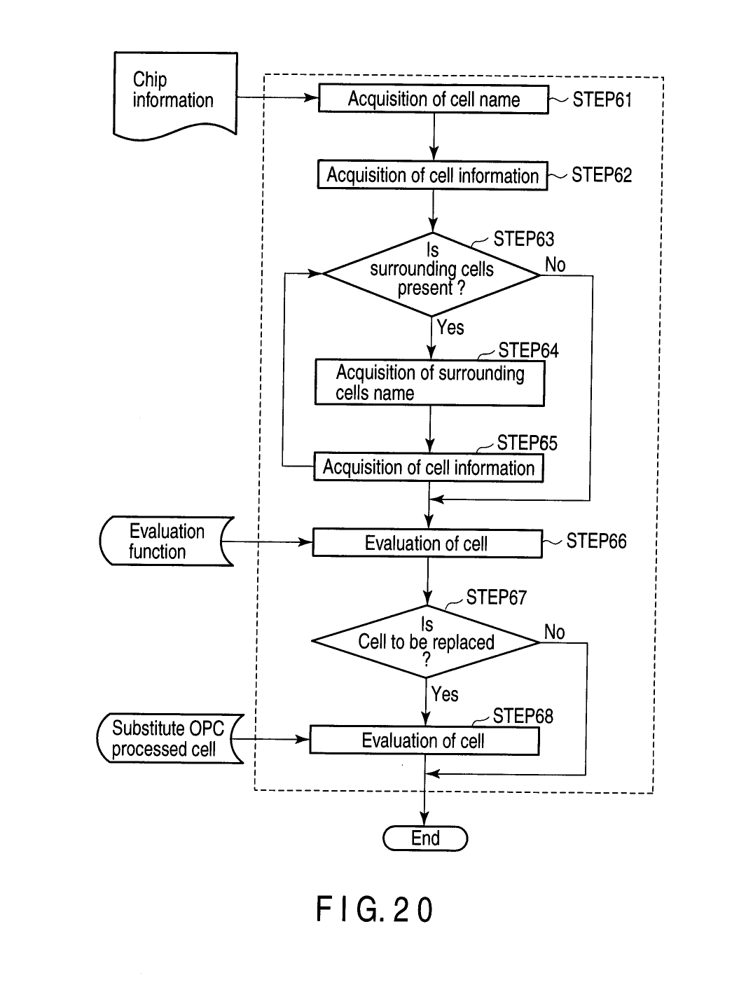

Next, the cell replacement method after the creation of the environmental profile will be described with reference to a flowchart of FIG. 20.

First, the cell name is obtained from chip information (STEP 61) and then information other than the name of the cell is obtained (STEP 62). The cell information includes arrangement information which contains at least one of the cell coordinates, the cell rotation information, the cell coordinates, the cell size, the pre-correction cell pattern shape, the number of vertices of the pre-correction cell pattern, the corrected correction cell pattern shape, and the number of vertices of the corrected cell pattern.

Next, a decision is made as to whether a cell is present around the target cell (STEP 63). If it is present, its name and information other than the name are obtained (STEP 64 and STEP 65). As in STEP 62, the cell information is arrangement information which contains at least one of the cell coordinates, the cell rotation information, the cell size, the pre-correction cell pattern shape, the number of vertices of the pre-correction cell pattern, the corrected cell pattern shape, and the number of vertices of the corrected cell pattern.

After the cell information has been obtained, a return is made to STEP 63. That is, as long as other surrounding cells are present, their names and information other than the names are obtained in succession.

After the names and information other than the names of all the cells are obtained, and it is determined that surrounding cells are present no longer in STEP 63, the cells are subjected to evaluation on the basis of the aforementioned evaluation function (environmental profile) (STEP 66).

A decision is then made whether to replace or not (STEP 67), and if the decision is that the cell is to be replaced, then it is replaced with substitute OPC processed cell data stored in the storage device 13 for evaluation (STEP 68). If a cell is to be replaced, the name of the cell is specified and then the cell is replaced with a substitute cell. A series of activities described above is carried out on all the cells contained in input data.

According to the process proximity effect correction apparatus and method as described above, for a cell arrangement which has an environmental profiled registered in the storage device 13, cells are replaced with substitute OPC processed cells registered in the storage device, thus allowing the processing time to be reduced without lowering accuracy. Moreover, in the presence of environmental profiles and the substitute OPC processed cells which are not registered in the storage device, they are registered in the storage device after correction, thus allowing the processing time to become decreased with use.

### Second Embodiment

FIG. 21 is a flowchart illustrating a process proximity correction method according to a second embodiment and another method of lithography verification.

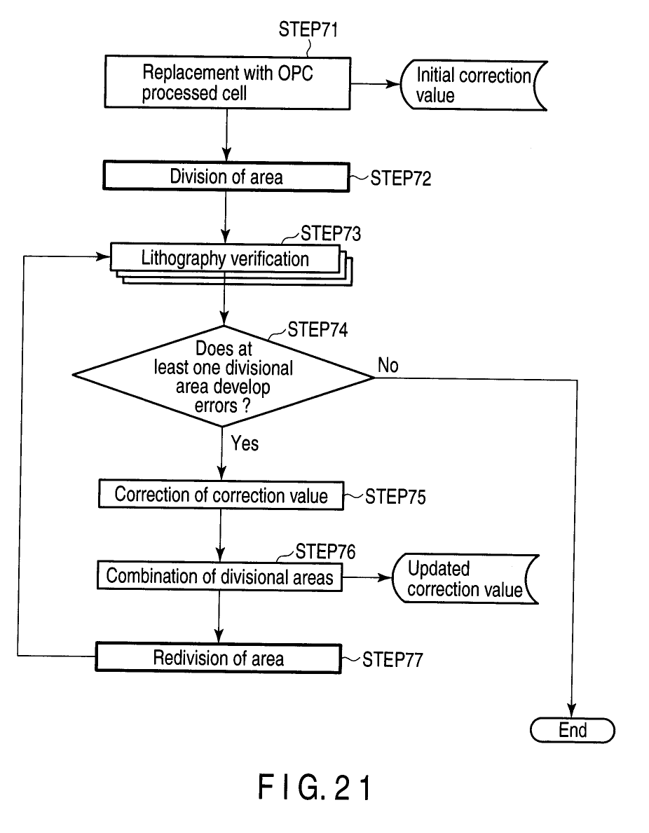

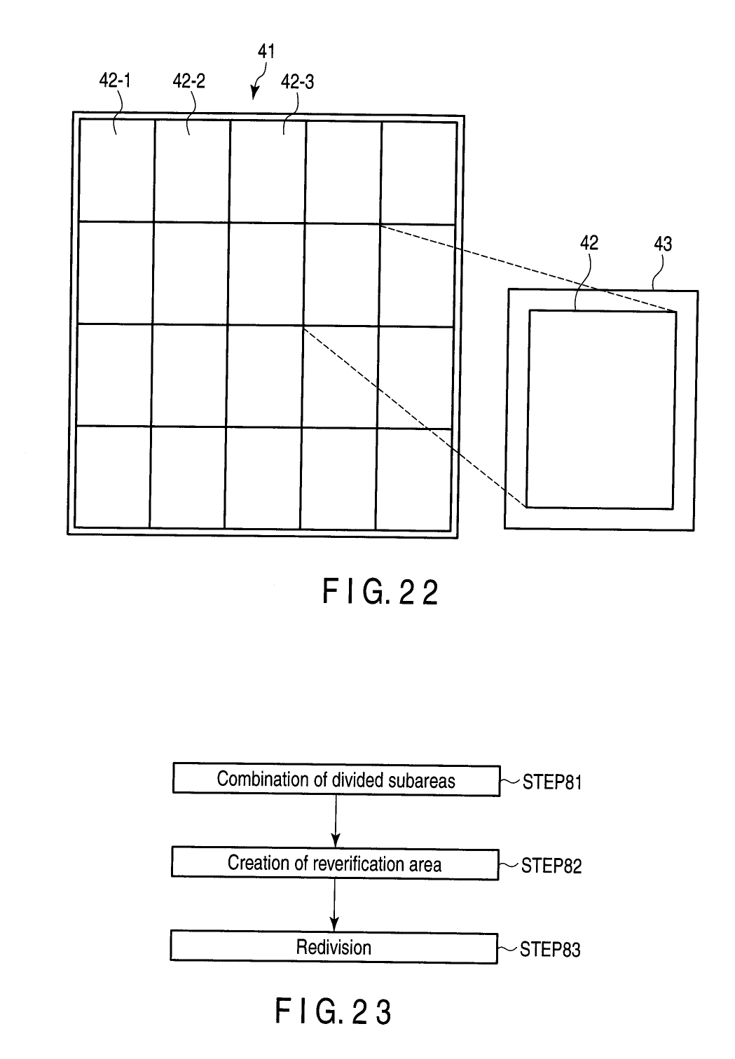

FIG. 22 is a plan view illustrating the concept of the lithography verification method shown in FIG. 21.

FIG. 23 is a flowchart illustrating redivision of an area in the lithography verification method shown in FIG. 21.

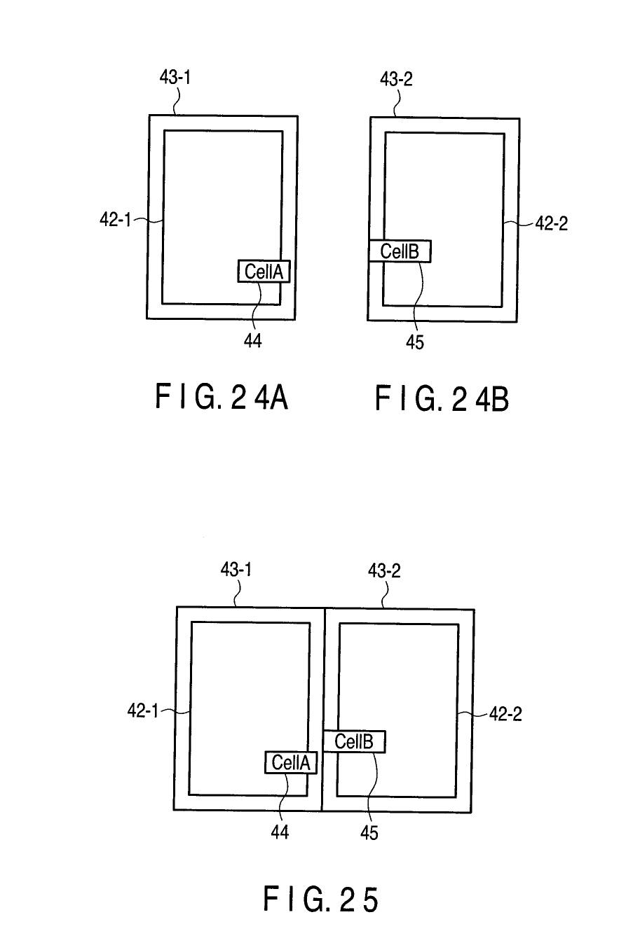

FIGS. 24A and 24B are pattern plan views illustrating the arrangement of divisional areas in the lithography verification method shown in FIG. 23.

FIG. 25 is a pattern plan view illustrating the step of combining the divisional areas in the lithography verification method shown in FIG. 23.

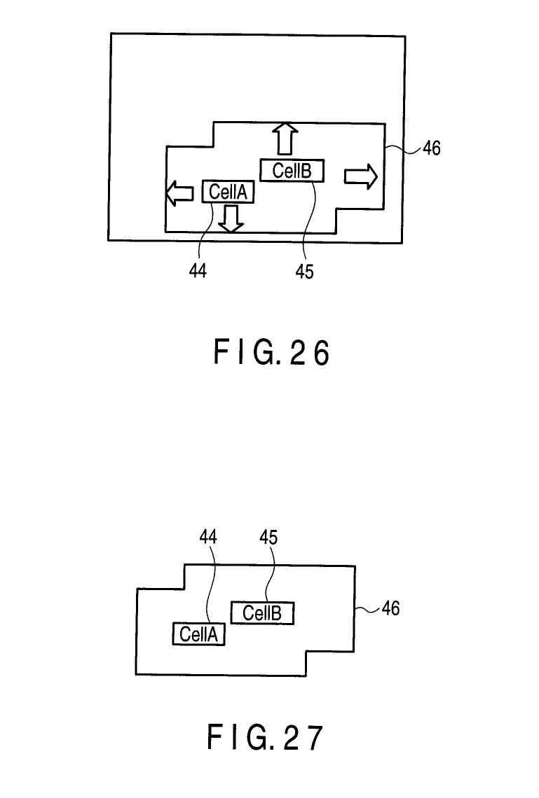

FIG. 26 is a pattern plan view illustrating the step of creating a reverification area in the lithography verification method shown in FIG. 23.

FIG. 27 is a pattern plan view illustrating the redivision step in the lithography verification method shown in FIG. 23.

In the second embodiment, as indicated by STEP 72 in FIG. 21, a step is carried out which divides an area defined by input data. In this example, as shown in FIG. 22, a chip 41 is divided into regular grid-like areas 42-1, 42-2, 42-3, (collectively indicated at 42). In making the divisional areas 42, a shared area 43 is given around each neighboring divisional area.

Subsequently, as shown in FIG. 21, lithography verification is made on each of the divisional areas 42 (STEP 73), and for each of portion determined error, its correction values is updated in the same way as described in the first embodiment (STEP 74 and STEP 75).

After that, the data of the divisional area after update is synthesized (STEP 76), the updated correction value is obtained. Then, the area is redivided (STEP 77), and lithography verification is made again on each of the redivided areas (STEP 73).

The redivision of the data from the synthesized divisional areas is performed as shown in FIGS. 23 through 27.

In STEP 81 of a flowchart shown in FIG. 23, the divisional areas are combined so that the shared areas 43-1 and 43-2 of the respective divisional areas 42-1 and 42-2 come into contact with each other as shown in FIGS. 24A, 24B and 25. Corrected cells 44 and 45 are contained in the boundary between the two areas 42-1 and 42-2. These cells 44 and 45 are neighboring. The cells 44 and 45 are expanded up to a fixed range (e.g., optical radius) to create a reverification area 46 (STEP 73).

After that, the created reverification area 46 is extracted for redivision as shown in FIG. 27 (STEP 83) and then lithography verification is carried out (STEP 73).

According to such a method as described above, a chip can be divided into areas of arbitrary area unit instead of cell unit in order to correct the process proximity effect.

### Third Embodiment

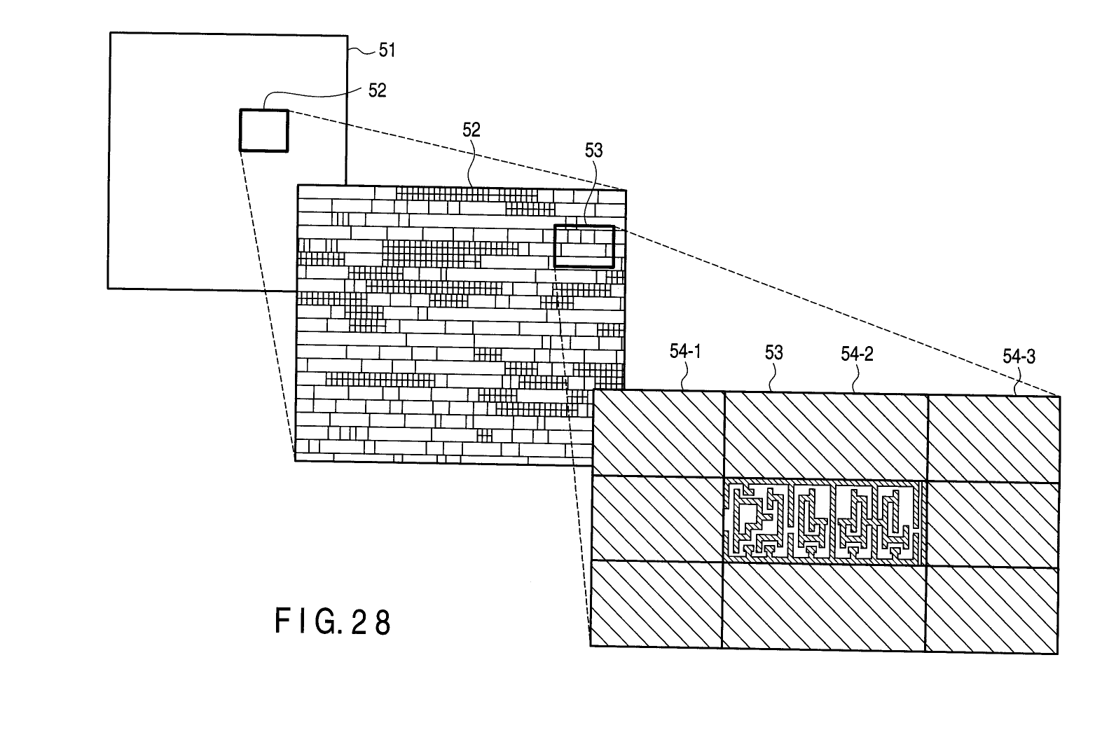

FIG. 28 is a flowchart illustrating a process proximity correction method according to a third embodiment and another concept of the lithography verification method shown in FIG. 21.

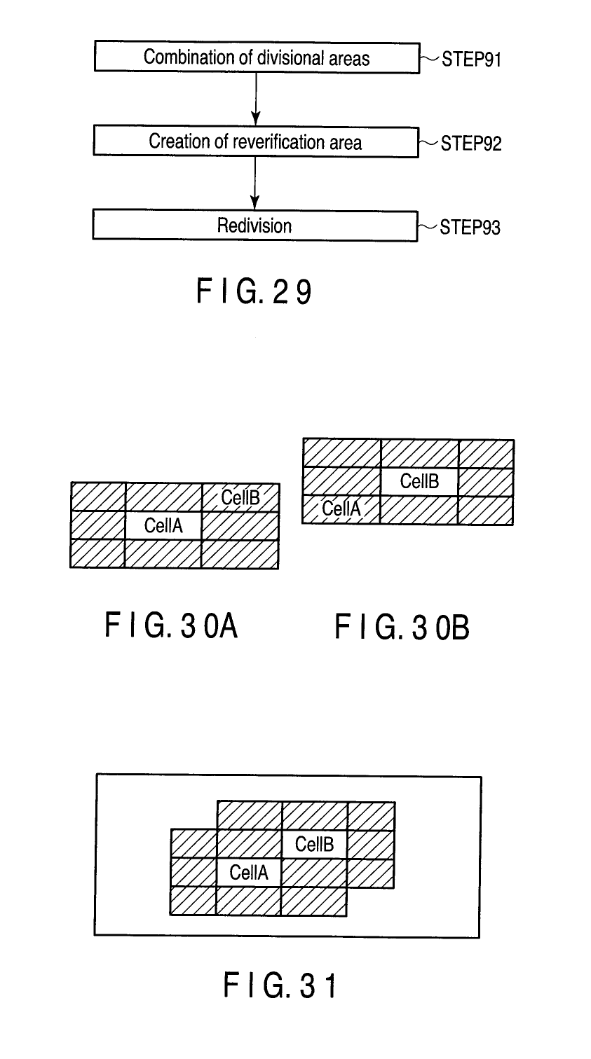

FIG. 29 is a flowchart illustrating the lithography verification method shown in FIG. 28.

FIGS. 30A and 30B are pattern plan views illustrating the arrangement of cells in the lithography verification method shown in FIG. 29.

FIG. 31 is a pattern plan view illustrating the step of combining the divisional areas in the lithography verification method shown in FIG. 29.

FIG. 32 is a pattern plan view illustrating the step of creating a reverification area in the lithography verification method shown in FIG. 29.

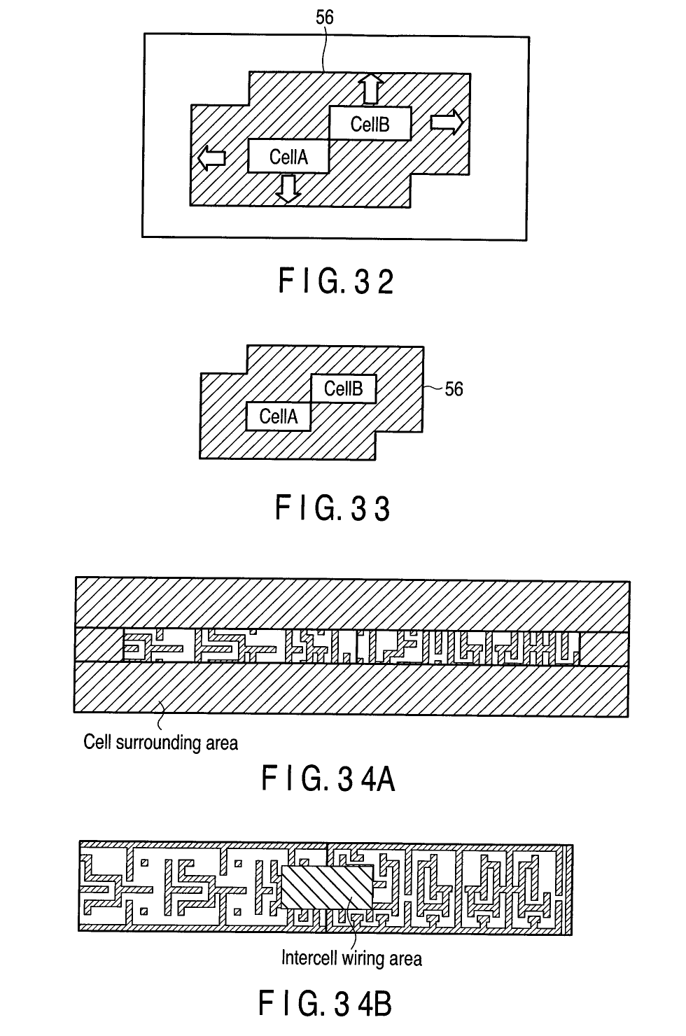

FIG. 33 is a pattern plan view illustrating the redivision step in the lithography verification method shown in FIG. 29.

The third embodiment adopts a dividing method in the STEP 72 of dividing the area defined by the input data, in which the dividing method divides the cells constituting the input data such that the cell and its surrounding cells are involved as shown in FIG. 28. This method extracts an area 53 for of the cells arranged on a chip 51 in a manner that the surrounding cells 54-1, 54-2, 54-3, . . . are included.

Subsequently, lithography verification is carried out on each of the divisional areas (STEP 73). For areas which develop errors, correction values are updated in the same as described in the first embodiment (STEP 74 and STEP 75).

After that, the data of the divisional areas after update are combined (STEP 76), and the correction values are obtained. The data is then redivided (STEP 77) and lithography verification is made again on the redivided data (STEP 73).

The steps from the divisional areas combining step through the data redivision step are carried out as shown in FIGS. 29 through 33.

In the step of combining the divisional areas (STEP 91) in a flowchart shown in FIG. 29, the area which contains the corrected cell (CellA) and its surrounding cells and the area which contains the corrected cell (CellB) and its surrounding cells are combined so that they overlap with each other as shown in FIGS. 30A, 30B and 31. The resultant area 55 is used as a reverification area 56 indicated hatched in FIG. 32 (STEP 92).

After that, the reverification area 56 is extracted as shown in FIG. 33 and divided again into areas (STEP 93). The lithography verification is made on each of the areas (STEP 73).

According to such a method as described above, the correction of process proximity effect is performed with incorporating the surrounding cells for each of the cells constituting the input data

### Fourth Embodiment

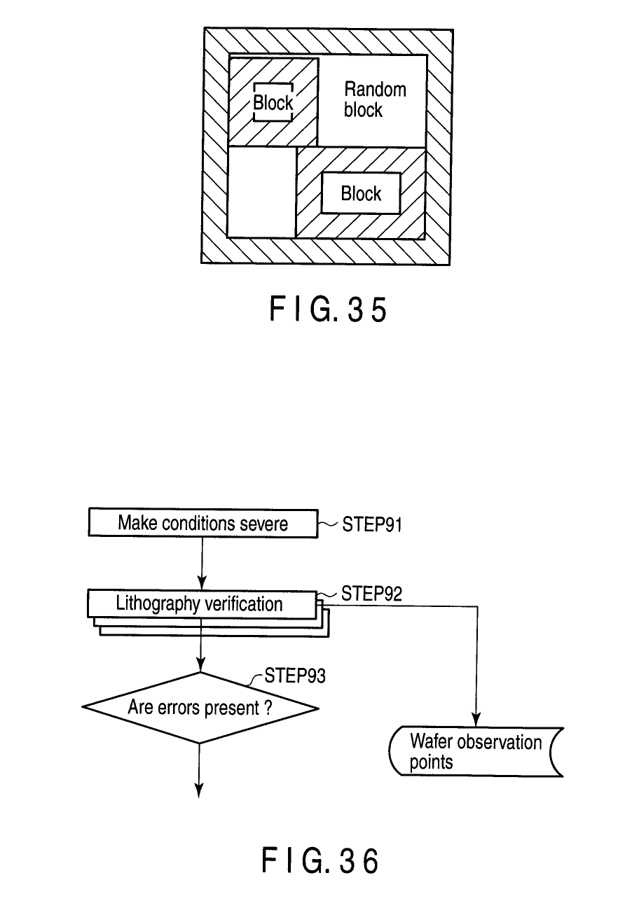

FIGS. 34A, 34B and 35 are diagrams for use in explanation of a process proximity correction method according to a fourth embodiment and are pattern plan views illustrating another lithography verification method. In the fourth embodiment, in order to reduce the number of subjected areas for lithography verification, a part of chip is extracted as a subjected area for lithography verification.

In the example of FIG. 34A, only the peripheral area of a cell is extracted as a subjected area for lithography verification as indicated by hatching. In the example of FIG. 34B, only the intercell wiring area is extracted as a subjected area for lithography verification as indicated by hatching. Furthermore, in the example of FIG. 35, only the peripheral areas of blocks are extracted as subjected areas for lithography verification as indicated by hatching.

Thus, the number of subjected areas for lithography verification can be reduced by extracting the part of chip as a subjected area for lithography verification.

### Fifth Embodiment

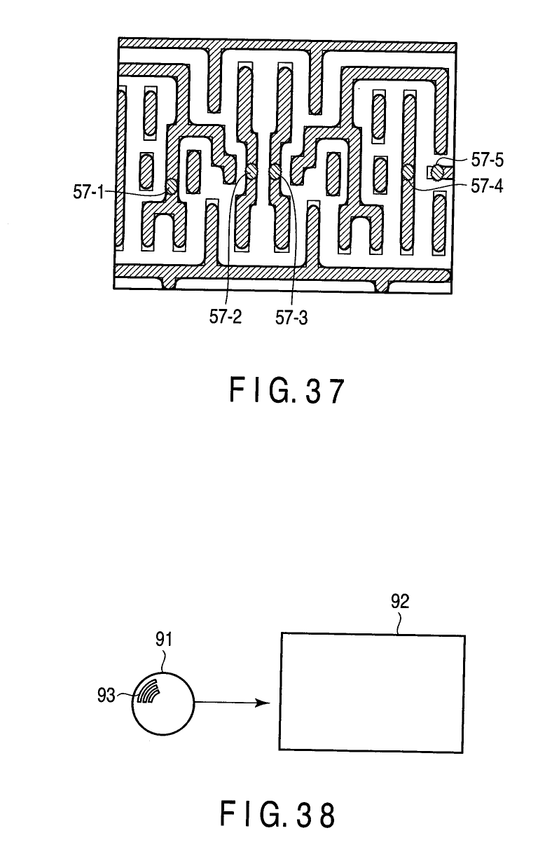

FIG. 36 is a flowchart illustrating a process proximity correction method according to a fifth embodiment and still another method of lithography verification. Moreover, FIG. 37 is a pattern plan view illustrating observation points in the lithography verification method shown in FIG. 36.

In the fifth embodiment, as a subjected area for lithography simulation-based verification, at least one of the cell boundary, the vicinity of wiring connecting intercells, the block boundary, the vicinity of critical path, and an area which is decided to be replaced in the environmental profiles described in the first embodiment is first identified.

Next, as shown in FIG. 36, the lithography simulation conditions are made severe (STEP 91). The lithography verification is made under the severe conditions (STEP 92) to extract observation points on a wafer. Thereby, the lithography simulation conditions are accelerated to output portions 57-1 to 57-5 which may develop errors though not fatal as wafer observation points as shown in FIG. 37.

According such a correction method as described above, since risky portions having the possibility of developing errors can be extracted as wafer observation points, they can be screened.

### Sixth Embodiment

In the first through fifth embodiments described so far, process proximity effect correction methods and correction apparatuses using these methods are described.

However, for example, a personal computer may have program instructions installed into it from a recording medium, which cause it to execute process proximity effect correction on design data of a semiconductor integrated circuit device.

FIG. 38 shows a computer program product of the embodiment. The computer program product 91 record a program 93 for enabling the system including a computer 92 to execute the lithography simulation method for correcting process proximity effect of the embodiment.

The computer program product 91 is, for example, a CD-ROM or DVD.

The program 93 includes program instructions corresponding to STEP1-STEP7 in FIG. 2, program instructions corresponding to STEP51-STEP58 in FIG. 14, or program instructions corresponding to STEP61-STEP68 in FIG. 20, for instance.

The program 93 is executed by using hardware resources, such as a CPU and memory in the computer 92 (in some cases, an external memory is used together). The CPU reads necessary data from the memory and performs the above steps on the data. The result of each step is stored temporarily in the memory according to need and read out when it becomes necessary by other instructions.

For example, the program instructions describe the following steps <1> to <8>:

<1> The instruction to input data in which a number of correction cell patterns are arranged in a place/route arrangement, and perform replacement with the substitute cells if the substitute OPC processed cells are registered.

<2> The instruction to make a decision of the presence or absence of arrangements which is not registered in the environmental profile.

<3> The instruction to execute lithography verification in the presence of the cell arrangement which is not registered in the environmental profile.

<4> The instruction to make a decision of the presence or absence of error in the lithography verification.

<5> The instruction to make a correction on the correction value if the error is detected.

<6> The instruction to make a registration of the cell in which the correction value is corrected as a substitute OPC processed cell.

<7> The instruction to create an environmental profile on the basis of the correction values in the absence of errors and create an environmental profile on the basis of corrections values after correction if the correction values are corrected.

<8> The instruction to register the created environmental profile in the environmental profiles.

According to a computer readable recording medium stored with such program instructions, a personal computer can be used as a process proximity effect correction apparatus.

As mentioned above, according to the first to sixth present embodiments, the method for correcting process proximity effect, the correction apparatus for correcting process proximity effect and the computer program product enabling the processing time to be reduced without lowering accuracy are obtained.

That is, the method for correcting process proximity effect of the present embodiment is a process proximity effect correction method for design data of a semiconductor integrated circuit device,

wherein the method comprises;

a first step of inputting data comprising corrected cell patterns which are arranged in a place/route arrangement,

a second step of conducting verification on the inputted data,

a third step of updating the inputted data at the first step or correction cell patterns constituting the inputted data at the first step based on result of the verification of the second step,

a fourth step of determining an environmental profile in a specific format for each of the correction cell patterns constituting the inputted data at the first step based on the arrangement information which contains at least one of the cell name of a correction cell pattern or its surrounding cell patterns, rotation angle of the cell, inversion information of the cell, the coordinates of the cell, the cell size, the shape of the pre-correction cell pattern, the number of vertices of the pre-correction cell pattern, the shape of the post-correction cell pattern, and the number of vertices of the post-correction cell pattern, and the verification result of the second step,

a fifth step of inputting the data comprising the corrected cell patterns which are arranged in the place/route arrangement, and the correction cell pattern updated at the third step,

a six step of replacing the correction cell patterns constituting the data comprising the corrected cell patterns which are arranged in the place/route arrangement inputted at the fifth step with the updated correction cell patterns inputted at the fifth step based on the environmental profile created at the fourth step,

a seventh step of identifying an area which is not registered in the environmental profile wherein the area belongs to the data comprising the corrected cell patterns which are arranged in the place/route arrangement inputted at the fifth step,

a eighth step of conducting a verification on the area identified at the seventh step,

a ninth step of updating the data comprising the corrected cell patterns which are arranged in the place/route arrangement inputted at the fifth step, or updating the correction cell patterns constituting the data comprising the corrected cell patterns which are arranged in the place/route arrangement inputted at the fifth step,

a tenth step of updating the environmental profile created at the fourth step based on result of the verification of the eighth step, and

steps of repeating the fifth to tenth steps sequentially.

The following (1)-(5) are preferable embodiments.

(1) The fourth step includes;

a step of obtaining at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of the correction cell patterns constituting the inputted data,

a step of obtaining at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of surrounding cells of the cell of which the arrangement information is obtained,

a step of obtaining result of the verification of the second step for each of the cells of which the arrangement information is obtained, and

a step of creating an evaluation function for determining whether to replace a cell or not, or for calling a substitute wherein the evaluation function is created by using statistical analysis of the arrangement information of the cells of which the arrangement information is obtained, or the arrangement information of the surrounding cells, or at least one of the result of the verification.

(2) The sixth step includes;

a step of obtaining at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of the correction cell patterns constituting the inputted data,

a step of obtaining at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of surrounding cells of the cell of which the arrangement information is obtained,

a step of determining whether to replace a cell or not based on the evaluation function, and

a step of replacing the cell with the correction cell pattern updated at the fifth step.

(3) The first step includes;

a step of dividing inputted data into divisional areas,

a step of conducting verification on the divisional areas,

a step of updating corrected data based on result of the verification,

a step of uniting divisional areas in which data is updated at the step, or uniting divisional areas in which data is not updated at the step, and

re-dividing the united date.

(4) the seventh step includes;

a step of identifying at least one of area selected form a group consisting of the cell boundary, the vicinity of wiring connecting intercells, the block boundary, the vicinity of critical path, and an area which is decided to be replaced in the environmental profiles.

(5) The second and seventh steps include respectively steps of outputting result of the conducted verification.

In addition, the computer program product of the embodiment is a computer program product configured to store program instructions for correcting process proximity effect of design data of a semiconductor integrated circuit device for execution on a computer system enabling the computer system to perform,

wherein the program instructions comprises;

a first instruction to input data comprising corrected cell patterns which are arranged in a place/route arrangement,

a second instruction to conduct verification on the inputted data,

a third instruction to update the inputted data at the first instruction or correction cell patterns constituting the inputted data at the first instruction based on result of the verification of the second instruction,

a fourth instruction to determine an environmental profile in a specific format for each of the correction cell patterns constituting the inputted data at the first instruction based on the arrangement information which contains at least one of the cell name of a correction cell pattern or its surrounding cell patterns, rotation angle of the cell, inversion information of the cell, the coordinates of the cell, the cell size, the shape of the pre-correction cell pattern, the number of vertices of the pre-correction cell pattern, the shape of the post-correction cell pattern, and the number of vertices of the post-correction cell pattern, and the verification result of the second instruction,

a fifth instruction to input the data comprising the corrected cell patterns which are arranged in the place/route arrangement, and the correction cell pattern updated at the third instruction,

a six instruction to replace the correction cell patterns constituting the data comprising the corrected cell patterns which are arranged in the place/route arrangement inputted at the fifth instruction with the updated correction cell patterns inputted at the fifth instruction based on the environmental profile created at the fourth instruction,

a seventh instruction to identify an area which is not registered in the environmental profile wherein the area belongs to the data comprising the corrected cell patterns which are arranged in the place/route arrangement inputted at the fifth instruction,

a eighth instruction to conduct a verification on the area identified at the seventh instruction,

a ninth instruction to update the data comprising the corrected cell patterns which are arranged in the place/route arrangement inputted at the fifth instruction, or updating the correction cell patterns constituting the data comprising the corrected cell patterns which are arranged in the place/route arrangement inputted at the fifth instruction,

a tenth instruction to update the environmental profile created at the fourth instruction based on result of the verification of the eighth instruction; and

instruction to repeat the fifth to tenth instructions sequentially.

The following (6)-(10) are preferable embodiments.

(6) The fourth instruction includes,

an instruction to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of the correction cell patterns constituting the inputted data,

an instruction to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of surrounding cells of the cell of which the arrangement information is obtained,

an instruction to obtain result of the verification of the second instruction for each of the cells of which the arrangement information is obtained, and

an instruction to create an evaluation function for determining whether to replace a cell or not, or for calling a substitute wherein the evaluation function is created by using statistical analysis of the arrangement information of the cells of which the arrangement information is obtained, or the arrangement information of the surrounding cells, or at least one of the result of the verification.

(7) The sixth instruction includes;

an instruction to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of the correction cell patterns constituting the inputted data,

an instruction to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of surrounding cells of the cell of which the arrangement information is obtained,

an instruction to determine whether to replace a cell or not based on the evaluation function, and

an instruction to replace the cell with the correction cell pattern updated at the fifth instruction.

(8) The first instruction includes;

an instruction to divide inputted data into divisional areas,

an instruction to conduct verification on the divisional areas,

an instruction to update corrected data based on result of the verification,

an instruction to unite divisional areas in which data is updated at the instruction, or uniting divisional areas in which data is not updated at the instruction, and

re-dividing the united date.

(9) The seventh instruction includes;

an instruction to identify at least one of area selected form a group consisting of the cell boundary, the vicinity of wiring connecting intercells, the block boundary, the vicinity of critical path, and an area which is decided to be replaced in the environmental profiles.

(10) The second and seventh instructions respectively include instructions to output result of the conducted verification.

In addition, the correction apparatus of process proximity effect of the present embodiment is a correction apparatus configured to correct process proximity effect of design data of a semiconductor integrated circuit device,

the correction apparatus comprises;

a first unit configured to input data comprising corrected cell patterns which are arranged in a place/route arrangement;

a second unit configured to conducting verification on the inputted data;

a third unit configured to updating the data inputted by the first step or correction cell patterns constituting the data inputted by the first unit based on result of the verification by the second unit;

a fourth unit configured to determine an environmental profile in a specific format for each of the correction cell patterns constituting the data inputted by the first unit based on the arrangement information which contains at least one of the cell name of a correction cell pattern or its surrounding cell patterns, rotation angle of the cell, inversion information of the cell, the coordinates of the cell, the cell size, the shape of the pre-correction cell pattern, the number of vertices of the pre-correction cell pattern, the shape of the post-correction cell pattern, and the number of vertices of the post-correction cell pattern, and the verification result by the second unit;

a fifth unit configured to input the data comprising the corrected cell patterns which are arranged in the place/route arrangement, and the correction cell pattern updated by the third unit;

a six unit configured to replace the correction cell patterns constituting the data comprising the corrected cell patterns which are arranged in the place/route arrangement inputted by the fifth unit with the updated correction cell patterns inputted by the fifth unit based on the environmental profile created by the fourth unit;

a seventh unit configured to identify an area which is not registered in the environmental profile wherein the area belongs to the data comprising the corrected cell patterns which are arranged in the place/route arrangement inputted by the fifth unit;

a eighth unit configured to conduct a verification on the area identified by the seventh unit;

a ninth unit configured to update the data comprising the corrected cell patterns which are arranged in the place/route arrangement inputted by the fifth unit, or updating the correction cell patterns constituting the data comprising the corrected cell patterns which are arranged in the place/route arrangement inputted by the fifth unit; and

a tenth unit configured to update the environmental profile created by the fourth unit based on result of the verification by the eighth unit.

The following (11)-(15) are preferable embodiments.

(11) The fourth unit includes;

a unit configured to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of the correction cell patterns constituting the inputted data;

a unit configured to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of surrounding cells of the cell of which the arrangement information is obtained;

a unit configured to obtain result of the verification of the second unit for each of the cells of which the arrangement information is obtained; and

a unit configured to create an evaluation function for determining whether to replace a cell or not, or for calling a substitute wherein the evaluation function is created by using statistical analysis of the arrangement information of the cells of which the arrangement information is obtained, or the arrangement information of the surrounding cells, or at least one of the result of the verification.

(12) The sixth unit includes;

a unit configured to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of the correction cell patterns constituting the inputted data;

a unit configured to obtain at least one arrangement information selected from a group consisting of cell name, rotation information of the cell, inversion information of the cell, the coordinates of the cell, the size of the cell, the shape of the pre-correction cell pattern, the number of vertices of the pre-correction cell pattern, the shape of the correction cell pattern, and the number of vertices of the correction cell pattern for each of surrounding cells of the cell of which the arrangement information is obtained;

a unit configured to determine whether to replace a cell or not based on the evaluation function; and

a unit configured to replace the cell with the correction cell pattern updated by the fifth unit.

(13) The first unit includes;

a unit configured to divide inputted data into divisional areas;

a unit configured to conduct verification on the divisional areas;

a unit configured to update corrected data based on result of the verification;

a unit configured to unite divisional areas in which data is updated by the unit, or uniting divisional areas in which data is not updated by the unit; and

re-dividing the united date.

(14) The seventh unit includes;

a unit configured to identify at least one of area selected form a group consisting of the cell boundary, the vicinity of wiring connecting intercells, the block boundary, the vicinity of critical path, and an area which is decided to be replaced in the environmental profiles.

(15) The second and seventh units respectively include units of outputting result of the conducted verification.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for correcting process proximity effect comprising:
providing a plurality of corrected cells which are arranged in a place/route arrangement, the plurality of corrected cells being obtained by correcting design data of a semiconductor integrated circuit device based on correction value for correcting process proximity effect correction;
determining whether a cell arrangement of the plurality of corrected cells arranged in the place/route arrangement is registered or not based on environmental profiles;
conducting a lithography verification if the plurality of corrected cells is determined to include the cell arrangement which is not registered in the environmental profiles, the lithography verification being performed on the plurality of corrected cells, wherein the corrected cell to be conducted the lithography verification corresponds to the cell arrangement not registered;
determining whether an error is found or not in the lithography verification;
correcting the corrected cell to which the lithography verification is conducted if the error is found and registering the cell arrangement of the corrected cell to which the lithography verification is conducted in the environmental profiles; and
registering the cell arrangement of the corrected cell to which the lithography verification is conducted if the error is not found.

2. The method according to claim 1,
wherein the creating the environmental profile comprises;
obtaining cell information of the corrected cell from chip information relating to the semiconductor integrated circuit device,
determining whether the corrected cell is surrounded by corrected cells or not based on the chip information,
obtaining cell information of the corrected cells surrounding the cell based on the chip information if the corrected cell is surrounded by the corrected cells,
creating an evaluation function by using the cell information of the corrected cell and the cell information of the corrected cells surrounding the cell.

3. The method according to claim 2,
wherein the evaluation function has a function for determining whether the corrected cell is acceptable or rejectable.

4. The method according to claim 2,
wherein the evaluation function has a function for calling the substitute cell.

5. The method according to claim 3,
wherein the function for determining whether the cell is acceptable or rejectable is performed by statistical analysis of information that includes the cell information of the corrected cell and the cell information of the corrected cells surrounding the corrected cell.

6. the method according to claim 1, further comprising:
dividing an area defined by the plurality of corrected cells into a plurality of divisional areas;
conducting a lithography verification on each of the plurality of divisional areas;
updating every divisional area on which an error is found in the lithography verification, the divisional area being updated by correcting the correction value;
uniting the plurality of divisional areas including the updated every divisional area;
dividing the united plurality of divisional areas into a plurality of areas, the plurality of areas comprises an area that includes the updated divisional areas;

7. The method according to claim 6,
wherein the updated divisional areas includes neighboring divisional areas.

8. The method according to claim 7,
further comprising: determining whether the area is acceptable or rejectable.

9. A correction apparatus for correcting process proximity effect comprising:
an input unit configured to input design data of a semiconductor integrated circuit device;
a lithography verification unit configured to perform a lithography verification for correcting process proximity effect of the design data;
a proximity effect correction process unit configured to correct correction value when an error is detected in a lithography verification by the lithography verification unit;
an environmental profile creating unit configured to create an environmental profile of a target cell and surrounding cells of the target cell;
a storage unit configured to store the design data, verification result of the lithography verification, correction result of the correction value, and the environmental profile;
an output unit configured to output the verification result of the lithography verification, and the correction result of the correction value;
a control unit configured to control operations of the input unit, the storage unit, the output unit, the lithography verification unit, the process proximity effect correction process unit, and the environmental profile creating unit;
wherein when the process proximity effect correction of the design data is performed,
inputting a plurality of corrected cells which are arranged in a place/route arrangement, the plurality of corrected cells being obtained by correcting design data of a semiconductor integrated circuit device based on correction value for correcting process proximity effect correction,
determining whether a cell arrangement of the plurality of corrected cells arranged in the place/route arrangement is registered or not based on environmental profiles by using the control unit based on storage information stored in the storage unit;
conducting a lithography verification by the lithography verification unit if the plurality of corrected cells is determined to include the cell arrangement which is not registered in the environmental profiles, the lithography verification being performed on the plurality of corrected cells, wherein the corrected cell to be conducted the lithography verification corresponds to the cell arrangement not registered;
determining whether an error is found or not in the lithography verification by the control unit;
correcting the corrected cell to which the lithography verification is conducted by the proximity effect correction process unit if the error is detected and storing the cell arrangement of the corrected cell to which the lithography verification is conducted in the environmental profiles;
storing the cell arrangement of the corrected cell to which the lithography verification is conducted in the storage unit if the error is not detected.

10. A computer program product configured to store program instructions for execution on a computer system enabling the computer system to perform:
an instruction to provide a plurality of corrected cells which are arranged in a place/route arrangement, the plurality of corrected cells being obtained by correcting design data of a semiconductor integrated circuit device based on correction value for correcting process proximity effect correction;
an instruction to determine whether a cell arrangement of the plurality of corrected cells arranged in the place/route arrangement is registered or not based on environmental profiles;
an instruction to conduct a lithography verification if the plurality of corrected cells is determined to include the cell arrangement which is not registered in the environmental profiles, the lithography verification being performed on the plurality of corrected cells, wherein the corrected cell to be conducted the lithography verification corresponds to the cell arrangement not registered;
an instruction to correct the corrected cell to which the lithography verification is conducted if the error is found and registering the cell arrangement of the corrected cell to which the lithography verification is conducted in the environmental profiles; and
an instruction to the cell arrangement of the corrected cell to which the lithography verification is conducted if the error is not found.
